(19) United States
(12) Patent Application Publication
(10) Pub. No.: US 2016/0139723 A1
(43) Pub. Date: May 19, 2016

(54) USER INTERFACE WITH TOUCH SENSOR

(71) Applicant: Sharp Kabushiki Kaisha, Osaka (JP)

(72) Inventors: Peter Thomas Bawden BRETT, Edinburgh (GB); Christopher James BROWN, Oxford (GB)

(21) Appl. No.: 14/546,594

(22) Filed: Nov. 18, 2014

(51) Int. Cl. G06F 3/041; G06F 3/0488; G06F 3/0481; G06F 1/16; G06F 3/0354

(52) U.S. Cl. CPC G06F 3/0416; G06F 1/1692; G06F 3/03547; G06F 3/04812; G06F 3/04883

(57) ABSTRACT

A hand-held electronic device includes a display for outputting visual information and a proximity-sensitive touch panel. The display is arranged on a first side of the electronic device, while the proximity-sensitive touch panel is arranged on a second side of the electronic device that is opposite the first side.

### TECHNICAL FIELD

The present disclosure relates generally to electronic devices and, more particularly, to electronic devices that utilize touch sensors that can detect objects touching a surface of the touch panel as well as at a distance from the surface of the touch panel.

### BACKGROUND ART

Most high-end portable and handheld electronic devices now include touch panels. These are most often used as part of a touchscreen, i.e., a display and a touch panel that are aligned so that the touch zones of the touch panel correspond with display zones of the display.

The most common user interface for electronic devices with touchscreens is an image on the display, the image having points that appear interactive. More particularly, the device may display a picture of a button, and the user can then interact with the device by touching, pressing or swiping the button with their finger or with a stylus. For example, the user can “press” the button and the touch panel detects the touch (or touches). In response to the detected touch or touches, the electronic device carries out some appropriate function. For example, the electronic device might turn itself off, execute an application, etc.

Two main problems have been identified with existing touchscreen-based user interfaces.
1. With reference to FIG. 1, when the user interacts with a touchscreen 100 the user's hand 101 obstructs the user's view of the display. This prevents the user from being able to see part of the screen 102, which may result in incorrect or undesired operation of the device. For example, the user may miss an important change to the displayed image. This can be a problem when watching videos or playing games.
2. With reference to FIG. 2, many uses of touchscreen-based user interfaces require the user to touch or swipe many times in a variety of places. For example, browsing the Internet on a smartphone requires clicking on hyperlinks, scrolling web pages, and entering text with an on-screen keyboard. Between each touch of the touch panel, the user has to move their hand away so that they can see the whole image being displayed. During a long session of using the device, it might be necessary for the user to move their hand backwards and forwards 300 dozens or even hundreds of times. These small, repetitive motions are tiring over a short time and may lead to musculoskeletal disorders over a longer period.

Previous attempts to solve these problems include placing a touch panel on the back of the device (a reverse-side touch panel) as disclosed, for example, in US2007/0103454 to Elias, Jan. 5, 2007, U.S. Pat. No. 8,395,584 to Griffin, Jul. 2, 2009 and WO 2013/033309 to Morton et al., Mar. 7, 2013. Unfortunately, such solutions introduce a new problem.
3. With reference to FIG. 3, the user cannot see exactly how their hands and fingers are positioned, because they are hidden behind a housing 502 of the device 500. This makes it much more difficult to accurately touch a specific position on the touch panel. For example, the user cannot see when their finger is aligned with a button shown on the display. The reduced ease-of-use means that it is not practical to completely replace a touchscreen with a reverse-side touch panel.

The solutions that use a reverse-side touch panel implement several different ways of working around the problem of blocked line-of-sight to the user's hands. Some solutions mitigate the blocked line-of-sight by incorporating an additional input device, such as a button. When the user touches the reverse-side touch panel, the device displays a cursor. When the user activates the other input device, the cursor's current location is used to choose an appropriate function to execute. Unfortunately, this solution reduces the usability and increases the cost of the electronic device by requiring an additional input device.

Other solutions use a pressure-sensitive touch panel instead of a separate additional input device. When the user presses harder on the touch panel, the device uses the current point of touch to choose an appropriate function. Unfortunately, if the user has to use extra force it leads to the sort of problematic repetitive motions that using a reverse-side touch panel is supposed to reduce. Also, state-of-the-art pressure-sensitive touch panels can either detect a single point of touch (U.S. Pat. No. 5,241,308 to Young, Aug. 31, 1993) or have to employ two touch sensors in one (US 2014/0092052 to Grunthaner et al., Apr. 3, 2004), resulting in increased cost.

Some solutions use both a touchscreen and a reverse-side touch panel. The reverse-side touch panel is not active unless the user specifically enables it via the touchscreen. Then the user can only activate a few application-specific functions by touching the reverse-side touch panel. For example, the device might show the next page of a book when the user touches the right-hand side of the reverse-side touch panel and the previous page when she touches the left-hand side. Unfortunately, this means that the reverse-side touch panel is not used as a general-purpose input device that fully replaces the touchscreen.

Recently, some touch panel sensors have been introduced that in addition to sensing an object touching a surface, can also detect objects at a distance from the surface (“proximity-sensitive touch panels”). Some of these panels can only detect one object at a distance, while others can detect multiple objects. Examples include US 2014/0009428 to Coulson et al., Jan. 9, 2014.

### SUMMARY OF INVENTION

An apparatus and method in accordance with the present disclosure provide a user input means for an electronic device, such as a hand-held electronic device. The electronic device includes a display for outputting visual information, and a proximity-sensitive touch panel for inputting information to the electronic device. The proximity-sensitive touch panel is arranged on a side of the electronic device opposite the display. In this manner, a user can hold the electronic device in one hand and accurately input data to the electronic device using the same hand.

According to one aspect of the invention, a hand-held electronic device includes: a display for outputting visual information arranged on a first side of the electronic device; and a proximity-sensitive touch panel arranged on a second side of the electronic device, wherein the second side is opposite the first side.

In one embodiment, the device includes a controller operatively coupled to the display and to the proximity-sensitive touch panel, the controller configured to modify the visual information to correspond to a location of an object sensed by the proximity-sensitive touch panel relative to the touch panel.

In one embodiment, the controller is configured to superimpose a shadow image of the object onto the visual information.

In one embodiment, the device includes the shadow image corresponds to an actual shape of the object.

In one embodiment, the controller is configured to superimpose an image of the object onto the visual information, the image including information corresponding to a distance of different portions of the object from the touch panel.

In one embodiment, the controller is configured to modify the visual information to include a first image portion for an object touching the touch panel and a second image portion for an object a distance from the touch panel.

In one embodiment, the controller is configured to vary at least one of a shape, size, color or opacity of the second image portion as a function of the distance of the object from the touch panel.

In one embodiment, the first or second image portion comprises a transparent portion.

In one embodiment, the first or second image portion is opaque or semi-opaque.

In one embodiment, the controller is configured to ignore predetermined touch events or proximity events.

In one embodiment, the controller is configured to utilize the modified visual information as a cursor.

In one embodiment, the controller is configured to change a shape of the cursor based on at least one of a position of the cursor within the visual information or a content of the visual information.

In one embodiment, the controller is configured to perform an action based on a location of the object relative to the touch panel.

In one embodiment, the action comprises executing an application.

In one embodiment, the device includes a size of the display matches a size of the touch panel.

In one embodiment, a size of the display is different from a size of the touch panel.

In one embodiment, the controller is configured to scale touch events and/or proximity events based on a size of the touch panel relative to a size of the display.

In one embodiment, the device comprises at least one of a mobile phone, a tablet PC, a hand-held gaming device or a hand-held gaming controller.

According to one aspect of the invention, a computer system includes: a host computer; and the electronic device as described herein.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings

### BRIEF DESCRIPTION OF DRAWINGS

In the annexed drawings, like references indicate like parts or features.

FIG. 1 shows how a user's hand blocks the view of the display when using a conventional touchscreen.

FIG. 2 shows how the user must repeatedly move their hand back and forth during an extended interaction with a conventional touchscreen.

FIG. 3 shows how a reverse-side touch panel is difficult to use because the user's view of their hand is blocked by the housing of the device.

FIG. 4 shows the positioning of a proximity-sensitive touch panel on the reverse side of an electronic device in accordance with the present disclosure.

FIG. 5 shows the positioning of a display on the front side of an electronic device in such a way that it aligns with the proximity-sensitive touch panel on the reverse side in accordance with the present disclosure.

FIG. 6 shows an exemplary visual representation in accordance with the present disclosure of the location of objects detected close but not touching the proximity-sensitive touch panel.

FIG. 7 shows an exemplary visual representation in accordance with the present disclosure of the location of objects detected touching the proximity-sensitive touch panel and the use of the location to select a device function.

FIG. 8 shows the use of highly detailed detection of objects touching or close to the proximity-sensitive touch panel to allow the user to “see through” an electronic device in accordance with the present disclosure.

FIG. 9 shows how the visual representation may be scaled in accordance with the present disclosure to allow the use of a proximity-sensitive touch panel when its size differs from that of the associated display.

FIG. 10 is a block diagram illustrating an exemplary electronic device in accordance with the present disclosure.

FIG. 11 is a flow chart illustrating exemplary steps for carrying out a method for using a proximity-sensitive touch panel in accordance with the present disclosure.

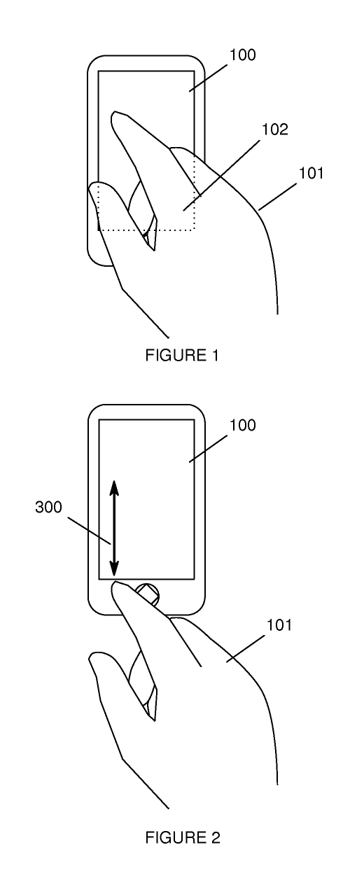

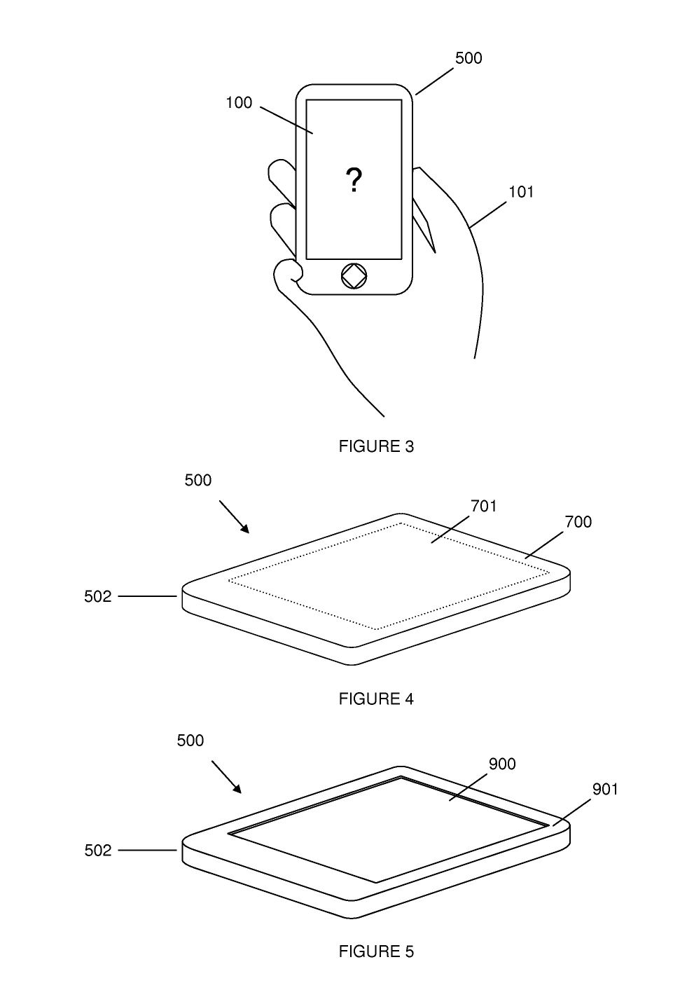

### DESCRIPTION OF REFERENCE NUMERALS

100—Touchscreen display.
101—User's hand.
102—Area of touchscreen display blocked from view by user's hand.
300—Repetitive motion of user's hand across touchscreen display.
500—Electronic device.
502—Housing of electronic device.
700—Side of housing of electronic device that normally faces away from the user.
701—Proximity-sensitive touch panel.
800—Controller.
802—Communication bus.
804—Processor.
806—Memory.
808—Data bus.
810—I/O module.
900—Display.
901—Side of housing of electronic device that normally faces towards the user.
902—Auxiliary touch panel.
1100—User's fingertip.
1101—Visual representation of object detected close to proximity-sensitive touch panel.
1102—Changed visual representation to reflect change in distance to nearby object.
1300—Part of displayed image representing electronic device function.
1301—Visual representation of object detected touching proximity-sensitive touch panel.
1500—Visual representation of objects detected close to or touching proximity-sensitive touch panel as a “shadow”.
1600-1610—Method steps for using a proximity-sensitive touch panel in accordance with the present disclosure.

### DETAILED DESCRIPTION OF INVENTION

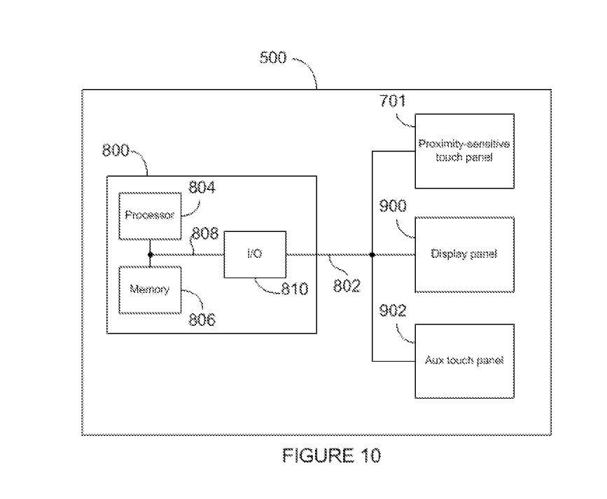

With reference to FIG. 4, an apparatus and method in accordance with the present disclosure provides a user interface for an electronic device 500 designed to be held in the user's hands. A side 700 of the device's housing 502 that normally faces away from the user has a proximity-sensitive touch panel 701. The touch panel 701 is arranged so that when the user is holding the device 500 in a relaxed position, their fingertips are located near a surface of the touch panel 701. The touch panel 701 is connected to a controller, which is in turn connected to a display (the controller is discussed below with respect to FIG. 10).

Arranging the proximity-sensitive touch panel 701 on a side that normally faces away from the user provides improved ergonomics, as the user can bring their fingers into contact with the touch panel 701 by moving their fingers, hands and arms only a small distance away from a relaxed position.

With additional reference to FIG. 5, the controller and display 900 may be part of the electronic device 500, or they may be connected to the electronic device by a cable or wirelessly. If the display 900 is built in to the device 500, then it may be placed on the side 901 of the device's housing 502 that normally faces towards the user. In this case, the positioning of the touch panel 701 also provides an improved user interface, because the user can interact with the touch panel 701 without obstructing their view of the display 900. This means that, for example, the controller can display an urgent message for the user's attention anywhere on the display 900 without any risk that the user may not see it due to their hand being in the way. In addition, because the user provides input from behind the device 500, it is not necessary for the user to repetitively move their hand over the display 900 and away from the display 900, thus reducing the risk of fatigue and long-term musculoskeletal disorders.

When the proximity-sensitive touch panel 701 and the display 900 are mounted on the opposite faces 700 and 901 of the device's housing, the sizes and positions of the display 900 and the proximity-sensitive touch panel 701 may be chosen so that they match. For example, the touch panel 701 and the display 900 may have similar dimensions, and may be positioned and aligned on parallel faces of the housing 502.

The proximity-sensitive touch panel 701 may be arranged so that the user may hold the device 500 using one hand and operate the touch panel 701 using the same hand or with the other hand. Alternatively, the user may use both hands at the same time to both hold the device and operate the touch panel.

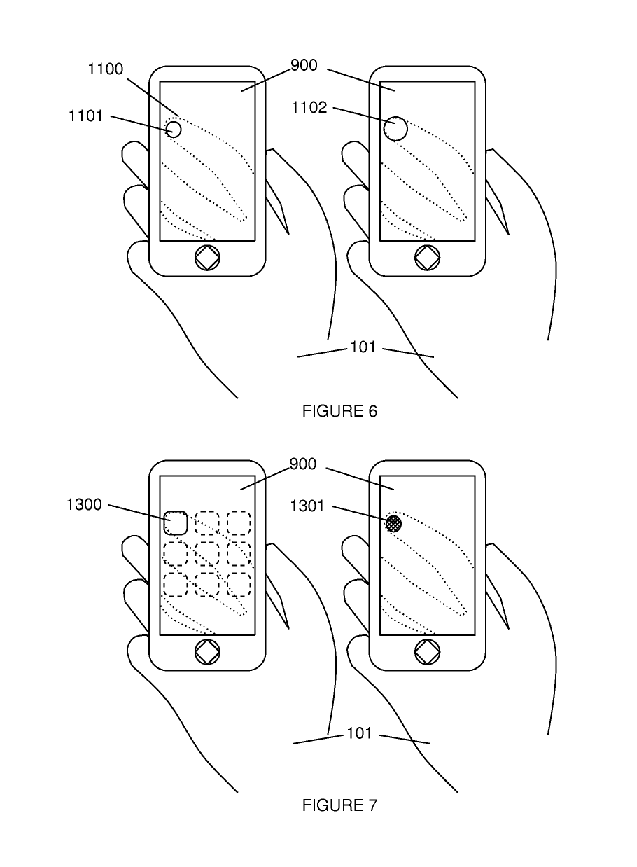

Referring now to FIG. 6, when the user moves one or more fingertips 1100 to a position close to the proximity-sensitive touch panel 701, it generates a signal indicating that there are one or more objects close to the touch panel 701. In response to the signal, the controller changes the image being displayed on the display 900. The modified image may include a graphical representation of the positions where objects have been detected by the touch panel 701. The graphical representation may be a pre-defined shape, such as a circle, pointer, arrow or the like. Additionally, the graphical representation may act as a cursor, such as a mouse cursor as is typical in graphical user interfaces. For example, the cursor shape may change depending on its position in the image and on the image content and may indicate the effect of touching the panel at that position.

Further, since proximity-sensitive touch panels are capable of measuring the distance to objects near the surface of the touch panel, the graphic representing each object may be varied to indicate how far away the object is from a surface of the touch panel 701. For example, a shape, such as a circle 1101, optionally having a transparent inner portion, may be shown in the display 900 for each detected object. In response to changes in the signal, the size 1102 or color of the shape may change to be indicative of the distance of the object from the surface.

The combination of the proximity-sensitive touch panel 701 and the visualisation generated by the controller provides an improved user interface, as it allows the user to “see” the position of their fingers even though the housing 502 of the electronic device 500 obstructs direct view of the fingers. This means that the user can accurately use the touch panel 701 to select specific locations with quick, light touches. There is no need for the device 500 to include an additional input device (for example, a button) for the user to select a specific location. This lowers the cost of the device 500, allows the user to hold the device 500 in a wide variety of ways, and allows software packages designed for use with a conventional touchscreen-based device to be used without modification.

If one or more of the user's fingertips 1100 make contact with the proximity-sensitive touch panel 701, it generates a signal indicating that there are one or more objects touching the touch panel 701. In response to the signal, the controller can carry out an appropriate function, depending on the positions where objects have touched the touch panel 701 and the way that the touching objects move.

For example, and with reference to FIG. 7, a smartphone might present a list of available “apps” by displaying a large icon for each app 1300. If the user's finger touches the touch panel 701 in a position corresponding to a particular icon and then is immediately removed, the controller may launch the “app”, but if the user slides her finger across the panel 701, the controller might scroll the list of apps 1300.

The controller may also change the image being shown by the display 900 to show a visual representation of the positions where objects have been detected touching the touch panel 701. The touching objects may be shown in a different way to the nearby objects. For example, if the nearby objects are represented by a shape outline, such as a ring, then the touching objects may be represented by a filled shape, such as a circle 1301, or other object having an opaque or semi-opaque portion.

The touch panel 701 may be capable of detecting one object at a distance from or touching the touch panel, detecting one object at a distance from and/or multiple objects touching the touch panel 701, or detecting multiple objects at a distance from and/or touching the touch panel 701. When the user holds the electronic device 500, some parts of their hands may be close to the proximity-sensitive touch panel 701 or may touch it. The controller may then determine which objects detected by the touch panel 701 are due to the way the user is holding the device 500, and exclude them from being visualised or used for selecting electronic device functions (e.g., the controller is configured to ignore predetermined combination of touch events and/or proximity events).

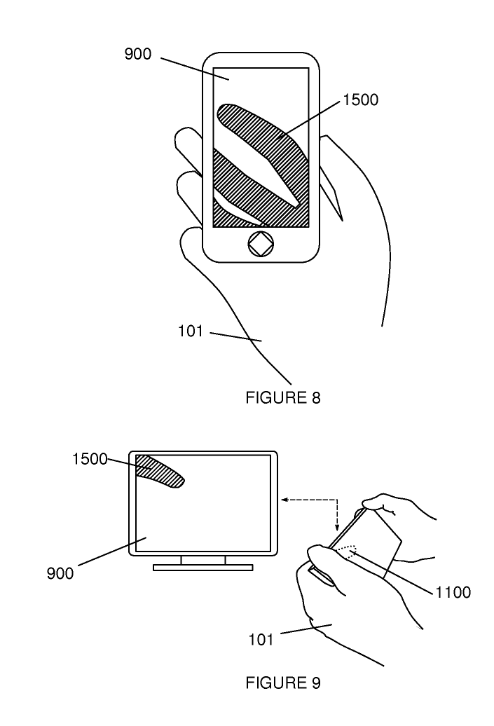

If the proximity-sensitive touch panel 701 can simultaneously detect a very large number of positions for objects at a distance from the touch panel 701 as well as objects touching the touch panel 701, then the controller may create an image that shows a detailed representation of any objects near the touch panel 701. For example, and with reference to FIG. 8, a “shadow” 1500 of the objects detected near the touch panel may be superimposed on the image that would otherwise normally be shown by the display.

The representation of the objects near the touch panel 701 may also depend on the distance to the objects. For example, the “shadow” of parts of the objects that are further away from the touch panel 701 may be colored with a different color to the parts that are close to the touch panel 701.

When the proximity-sensitive touch panel 701 and the display 900 have a similar size, position and alignment, then the controller may be configured to take advantage of such alignment. The controller may indicate objects in the image sent to the display 900 so that the position of the visual representation 1500 is at exactly the same position as the object would appear if the electronic device was transparent.

This “see-through” function of the controller illustrated in FIG. 8 also provides an improved user interface. More specifically, the “see-through” function makes it easy for the user to see where their fingers and other parts of their hands are while interacting with the electronic device 500. This further reduces the likelihood of incorrect or inaccurate input using the reverse-side touch panel 701.

Since the proximity-sensitive touch panel 701 and the display 900 are mounted on opposite sides of the device's housing 502, the display 900 may be a touchscreen module. It may include a conventional touch panel, or a proximity-sensitive touch panel. Providing both a conventional front-side touch panel and a proximity-sensitive reverse-side touch capability also provides an improved user interface. By allowing the user to interchangeably provide input to the electronic device 500 by either the front-side or reverse-side touch input, the user can choose either or both, depending on what is most appropriate for the particular situation, application or use-case at any given time.

The proximity sensitive touch panel 701 may be larger or smaller than the display 900. If the touch panel 701 and the display 900 are different sizes, then the controller may appropriately transform the positions of the objects detected by the touch panel 701. For example, the controller could scale the positions so that the top left corner of the touch panel 701 corresponds to the top left corner of the display 900 and the bottom right corner of the touch panel 701 corresponds to the bottom right corner of the display 900. This is illustrated in FIG. 9.

The electronic device 500 may be a mobile computing device, such as a mobile phone or tablet PC, a hand-held gaming console or gaming controller. The electronic device may have a display 900 on the side 901 of the device's housing normally facing the user and a proximity-sensitive touch sensor 701 on the opposite side 700. The electronic device 500 may have a number of other input devices, such as buttons. These may be arranged so that they operated by the user's thumbs or fingers at the same time as using the reverse-side touch panel.

The controller and the display may form part or parts of another device, such as a gaming console or computer workstation. In that case, the handheld electronic device may then be used as a controller or other input device for the gaming console or computer workstation.

The reverse-side proximity-sensitive touch panel 701 provides an improved user interface for a hand-held gaming applications. Often, video games require multiple inputs to be provided simultaneously, and demand a quick response from the user. The proximity-sensitive touch panel 701 can be used to input a position without using another input device. This reduces the number of steps needed to input a position, decreasing the user's response time, and means that the user's other fingers, etc. may be used to simultaneously provide additional inputs.

Referring to FIG. 10, illustrated is a block diagram of an exemplary electronic device 500 (e.g., a hand-held electronic device) in accordance with the present disclosure. As discussed above, the electronic device 500 includes a display 900 for outputting visual information, the display 900 arranged on a first side 901 of the electronic device 500. The electronic device 500 also includes a proximity-sensitive touch panel 701, the touch panel 701 arranged on a second side 700 of the electronic device 500, the second side being opposite the first side. Optionally, the electronic device may include a second touch panel 902 arranged on the first side 901 of the electronic device (e.g., over the display 900). The second touch panel 902 may be configured to detect a location of a touching object on a surface of the touch panel 902. Alternatively, the touch panel 902 may be configured to detect a location of a touching object on a surface of the touch panel 902 as well as a proximity of an object relative to the touch panel 902.

A controller 800 is operatively coupled to the touch panels 701, 902 and to the display 900 via a communication bus 802. The communication bus 802 may be any conventional communication bus known in the art, such as a serial communication bus, a parallel communication bus, etc. The controller 800 includes a processing device 804, such as a microprocessor, dedicated circuitry, or the like. The processor 804 is communicatively coupled to a memory 806, such as volatile memory and/or non-volatile memory via a data bus 808. An output module 810 is connected to the data bus 808 and the communication bus 802 to enable data to be exchanged between the controller 800, the touch panels 701, 902 and display 900.

The controller 800 is configured present visual information for viewing on the display 900, and based on data received from the touch panel(s) 701 and 902, modify the visual information to correspond to a location of an object relative to the touch panel 701. In one embodiment, the controller 800 is configured to superimpose a shadow image of an object touching the touch panel 701 and/or in close proximity to the touch panel 701 onto the visual information. The shadow image can be simple representation of the object or can correspond to an actual shape of the object, and may be superimposed onto the visual information. In one embodiment, the superimposed image includes information corresponding to a distance of different portions of the object from the touch panel. In this regard, the controller 800 may modify the visual information to include a first image portion for an object touching the touch panel 701 and a second image portion for an object a distance from the touch panel 701, wherein at least one of a size, color or opacity of the second image portion is varied as a function of the distance of the object from the touch panel 701.

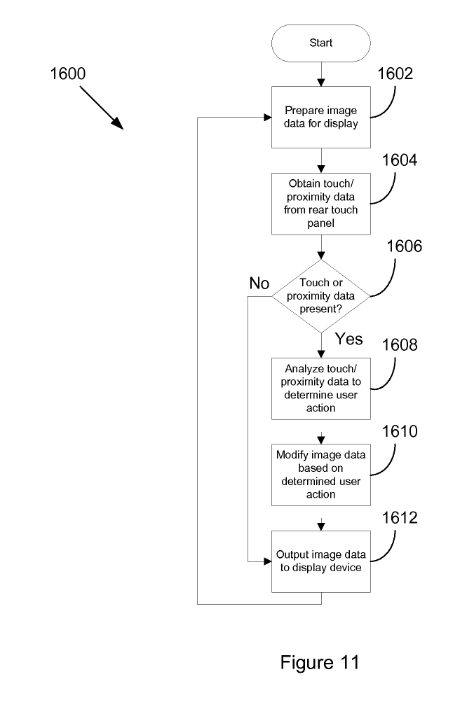

Referring now to FIG. 11, illustrated are exemplary steps 1600 for displaying an image in accordance with the present disclosure. The exemplary method may be carried out by executing logic within the controller 800, for example. Thus, the flow chart of FIG. 11 may be thought of as depicting steps of a method carried out by the controller 800. Although FIG. 11 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

Beginning at step 1602, the controller 800 prepares image data for presentation on the display 900. In presenting the image data, the controller 800 may render the image data based on instructions stored in memory 806 and executed by the processor 804. Alternatively or additionally, the image data may be rendered based on information from another device (not shown) and/or at least partially rendered by the other device.

Next at step 1604 the controller 800 obtains touch/proximity data from the proximity-sensitive touch panel 701. As noted above, such data may be communicated to the controller 800 via communication bus 802. For example, if a user's hand is not near or touching the touch panel 701, then the touch panel 701 may not provide any touch/proximity data to the controller 800. However, if the user's hand is near to or touching the touch panel 701, the touch panel 701 will generate data corresponding to the presence of the user's hand.

Moving to step 1606, the controller 800 determines if it has received touch/proximity data from the touch panel 701. If the controller 800 has not received data from the touch panel corresponding to the presence of the user's hand relative to the touch panel 701, then the method moves to step 1612 and the controller 800 displays the image data without altering the image data. However, if the controller 800 has received data from the touch panel 701 corresponding to the presence of the user's hand relative to the touch panel 701, then the method moves to step 1608 where the controller 800 analyses the touch/proximity data.

In analysing the touch/proximity data, the controller 800 may identify data corresponding to a touch event on the touch panel 701 as well as data corresponding to a proximity event relative to the touch panel 701. As used herein, a touch event refers to physical contact between an object and a surface of the touch panel 701, while a proximity event refers to an object that is not touching the touch panel 701 but is within a detection range of the touch panel 701.

Based on the presence of one or more touch events and/or one or more proximity events, the controller 800 generates image data that will be combined with and/or used to modify the original image data. Such generated image data may include simple geometric objects, such as circles, rings, squares, etc., using different colors or opacities to distinguish between a touch event and a proximity event, generating a shadow image of the object, generating an actual image of the object, etc. as described herein.

At step 1610 the controller 800 modifies the original image data based on the generated image data to create new image data corresponding to the touch event and/or proximity event. At step 1612, the image data (modified) is output for viewing on the display 900. The method then moves back to step 1602 and repeats.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

### INDUSTRIAL APPLICABILITY

This invention can be applied for hand-held industrial and consumer electronic devices. It is ideally suited to application in mobile phones, tablet PCs, and hand-held gaming consoles. It is also well-suited to application in hand-held industrial and consumer electronic input devices, such as for gaming consoles and desktop PCs.

1. A hand-held electronic device, comprising:
a display for outputting visual information arranged on a first side of the electronic device; and
a proximity-sensitive touch panel arranged on a second side of the electronic device, wherein the second side is opposite the first side.

2. The device according to claim 1, further comprising a controller operatively coupled to the display and to the proximity-sensitive touch panel, the controller configured to modify the visual information to correspond to a location of an object sensed by the proximity-sensitive touch panel relative to the touch panel.

3. The device according to claim 2, wherein the controller is configured to superimpose a shadow image of the object onto the visual information.

4. The device according to claim 3, wherein the shadow image corresponds to an actual shape of the object.

5. The device according to claim 2, wherein the controller is configured to superimpose an image of the object onto the visual information, the image including information corresponding to a distance of different portions of the object from the touch panel.

6. The device according to claim 2, wherein the controller is configured to modify the visual information to include a first image portion for an object touching the touch panel and a second image portion for an object a distance from the touch panel.

7. The device according to claim 6, wherein the controller is configured to vary at least one of a shape, size, color or opacity of the second image portion as a function of the distance of the object from the touch panel.

8. The device according to claim 6, wherein the first or second image portion comprises a transparent portion.

9. The device according to claim 6, wherein the first or second image portion is opaque or semi-opaque.

10. The device according to claim 2, wherein the controller is configured to ignore predetermined touch events or proximity events.

11. The device according to claim 2, wherein the controller is configured to utilize the modified visual information as a cursor.

12. The device according to claim 11, wherein the controller is configured to change a shape of the cursor based on at least one of a position of the cursor within the visual information or a content of the visual information.

13. The device according to claim 2, wherein the controller is configured to perform an action based on a location of the object relative to the touch panel.

14. The device according to claim 13, wherein the action comprises executing an application.

15. The device according to claim 1, wherein a size of the display matches a size of the touch panel.

16. The device according to claim 1, wherein a size of the display is different from a size of the touch panel.

17. The device according to claim 16, wherein the controller is configured to scale touch events and/or proximity events based on a size of the touch panel relative to a size of the display.

18. The device according to claim 1, wherein the device comprises at least one of a mobile phone, a tablet PC, a hand-held gaming device or a hand-held gaming controller.

19. A computer system, comprising:
a host computer; and
the electronic device according to claim 1 communicatively coupled to the host computer.
